(19) United States
(12) Patent Application Publication
(10) Pub. No.: US 2026/0054878 A1
(43) Pub. Date: Feb. 26, 2026

(54) LABEL PICKUP MODULE, LABEL PICKUP DEVICE, AND LABEL PICKUP METHOD USING THE SAME

(71) Applicant: Samsung Electronics Co., Ltd., Suwon-si (KR)

(72) Inventors: Jinsu HEO, Suwon-si (KR); Youngwan KIM, Suwon-si (KR); Chilhoon LEE, Suwon-si (KR)

(73) Assignee: Samsung Electronics Co., Ltd., Suwon-si (KR)

(21) Appl. No.: 19/170,144

(22) Filed: Apr. 4, 2025

(30) Foreign Application Priority Data
Aug. 20, 2024 (KR) 10-2024-0111209

(51) Int. Cl. B65C 9/14; B25J 15/06

(52) U.S. Cl. CPC B65C 9/14; B25J 15/0691

(57) ABSTRACT

According to some example embodiments, a label pickup module may include a pad part including cells and suction holes penetrating through each cell from one surface of each of the cells contacting labels to the other surface; an adsorption flow path part on an upper portion of the pad part and an air movement passage formed therein, communicating with the suction holes; a rod parts having one side fixed to each of the cells and independently movable up and down; a body part on the other side of the rod parts, including rooms having a hollow shape configured to move while accommodating each of the rod parts, and having air holes configured to move air through each of the rooms; and an air blocking unit configured to open and close the air holes.

### CROSS-REFERENCE TO RELATED APPLICATION

This application claims priority to and the benefit of Korean Patent Application No. 10-2024-0111209 filed in the Korean Intellectual Property Office on Aug. 20, 2024, the entire contents of which are incorporated herein by reference.

### BACKGROUND OF THE INVENTION

### (a) Field of the Invention

The present disclosure relates to label pickup modules, label pickup devices, and label pickup methods using the same.

### (b) Description of the Related Art

A product manufacturing process may include a label attachment process. The process of picking up a label and attaching the label to a product may be performed manually depending on the product, but in most cases, a label attachment device is used. A general label attachment device moves while fixing a label to a pad of the label attachment device and attaches the label to a product.

In the case of semiconductor package products that require precision in attachment, labels having various sizes are used, and pads that correspond to the sizes of the labels are used. Corresponding to the size of the label means that an area of the contact part of the pad that comes into contact with the label corresponds to an area of the label. The label attachment device for using vacuum adsorption force to fix a label may use the pad corresponding to the size of the label in order to increase adsorption force between a contact surface of the label and a contact surface of the pad.

However, the conventional label attachment device has a problem in that it requires a separate space for loading the pads in the equipment as a type of pads vary. In addition, there is the inconvenience of having to replace the pads of the label attachment device as the sizes of the labels to be attached change.

In particular, as the size of the semiconductor package has recently become smaller, the sizes of the labels have become more diverse, so it is considered that the types of pads should be increased. Accordingly, it is advantageous to develop technology for a label pickup device that may pick up labels having various sizes with one device and attach the labels to a product without replacing pads.

### SUMMARY OF THE INVENTION

The present disclosure attempts to provide label pickup modules, label pickup devices, and label pickup methods using the same capable of picking up labels having various sizes without replacing a pad by configuring a pad part into a plurality of cells and adjusting heights of each cell to change a shape of the pad part to correspond to a contact area with a label.

According to some example embodiments, a label pickup module may include a pad part including a plurality of cells and a plurality of suction holes penetrating through each cell from one surface of each of the plurality of cells contacting labels to the other surface; an adsorption flow path part on an upper portion of the pad part and an air movement passage formed therein, communicating with the plurality of suction holes; a plurality of rod parts having one side fixed to each of the cells and independently movable up and down; a body part on the other side of the plurality of rod parts, including a plurality of rooms having a hollow shape configured to move while accommodating each of the plurality of rod parts, and having a plurality of air holes configured to move air through each of the plurality of rooms; and an air blocking unit configured to open and close the plurality of air holes.

According to some example embodiments, a label pickup device may include a label pickup module including a pad part including a plurality of cells and a plurality of suction holes penetrating through each cell of the plurality of cells, an adsorption flow path part having an air movement passage communicating with the plurality of suction holes, a body part on the other side of a plurality of rod parts having one side fixed to each cell, and an air blocking unit configured to block air movement with an inside of the body part; a jig module including divided jig cells corresponding to the plurality of cells, the plurality of jig cells configured to be independently moveable up and down; and a movement module connected to the label pickup module and configured to move the label pickup module.

According to still some example embodiments, a label pickup method of picking up a label using a label pickup device having a pad part including a plurality of cells may include changing a shape of the pad part of the label pickup module to correspond to a size of the label; and picking up the label by the pad part whose shape is changed.

According to example embodiments, since the shape of the pad part that comes into contact with the label is changed to correspond to the size of the label, the label pickup device may pick up labels having various sizes without replacing the pad part.

### BRIEF DESCRIPTION OF THE DRAWINGS

FIG. 1 is a diagram illustrating a label pickup module according to some example embodiments.

FIGS. 2A and 2B and 3A and 3B are diagrams for describing a change in shape of a pad part of the label pickup module according to some example embodiments.

FIGS. 4A to 4C are diagrams for describing that the pad part of the label pickup module according to some example embodiments can correspond to labels having various sizes.

FIG. 5 is a diagram for describing a configuration of a label pickup module according to some example embodiments.

FIGS. 6A to 6D are diagrams illustrating a process of picking up a label using the label pickup module according to some example embodiments.

FIGS. 7A and 7B and 8A and 8B are diagrams for describing whether a suction hole is opened or closed during a process of picking up a label by the label pickup module according to some example embodiments.

FIGS. 9A to 9C are diagrams illustrating a label pickup module according to some example embodiments.

FIGS. 10A to 10D are diagrams illustrating a label pickup module according to some example embodiments.

FIG. 11 is a diagram illustrating a detachable structure of the label pickup module according to FIGS. 10A to 10D.

FIG. 12 is a diagram for describing a configuration of a label pickup device according to some example embodiments.

FIG. 13 is a diagram illustrating a label pickup method according to some example embodiments.

FIGS. 14 to 17A to 17E are diagrams illustrating a process of changing a shape of the pad part of the label pickup module to correspond to the size of a label in the label pickup method according to FIG. 13.

FIGS. 18 to 21A to 21E are diagrams illustrating a process of picking up the label by the pad part of a label pickup module and detaching the label from the pad part in the label pickup method according to FIG. 13.

### DETAILED DESCRIPTION OF THE EMBODIMENTS

Hereinafter, example embodiments of the present disclosure will be described in detail with reference to the accompanying drawings so that those skilled in the art to which the present disclosure pertains may easily practice the present disclosure. The present disclosure may be modified in various different forms, and is not limited to embodiments provided in the present specification.

Portions unrelated to the description will be omitted in order to obviously describe the present disclosure in the drawings, and identical or similar components will be denoted by the same reference numerals throughout the present specification.

In addition, the size and thickness of each component illustrated in the drawings are arbitrarily indicated for convenience of description, and the present disclosure is not necessarily limited to the illustrated those. In the drawings, to clearly express the various layers and areas, the thickness has been enlarged. In addition, in the accompanying drawings, thicknesses of some of layers and regions have been exaggerated for convenience of explanation.

Throughout the present specification, when any one part is referred to as being “connected to” another part, it means that any one part and another part are “directly connected to” each other or are “indirectly connected to” each other with the other part interposed therebetween. In addition, unless explicitly described to the contrary, the word “comprise”, and variations such as “comprises” or “comprising”, will be understood to imply the inclusion of stated elements but not the exclusion of any other elements.

In addition, it will be understood that when an element such as a layer, a film, a region, or a substrate is referred to as being “above” or “on” another element, it may be directly on another element or may have an intervening element present therebetween. In contrast, when an element is referred to as being “directly on” another element, there are no intervening elements present. In addition, when an element is referred to as being “on” a reference element, it can be positioned on or beneath the reference element, and is not necessarily positioned on the reference element in an opposite direction to gravity.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

Further, throughout the specification, the word “plane” refers to a view when a target is viewed from the top, and the word “cross section” refers to a view when a cross section of a target taken along a vertical direction is viewed from the side.

Hereinafter, a label pickup module 100, a label pickup device 10, and a label pickup method using the same according to some example embodiments of the present disclosure will be described in more detail with reference to the drawings.

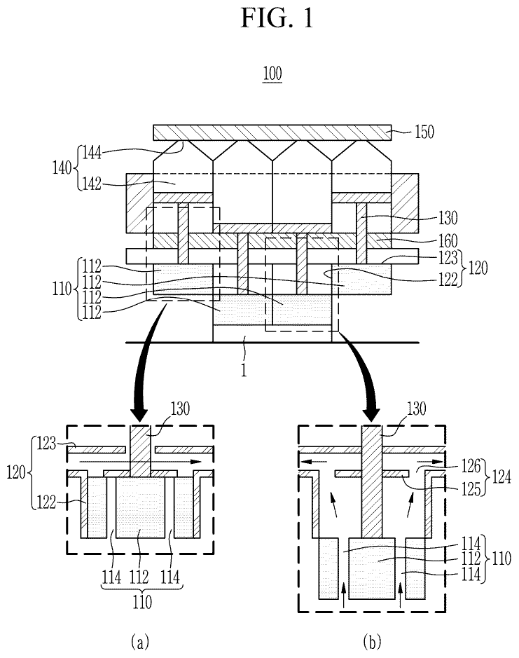

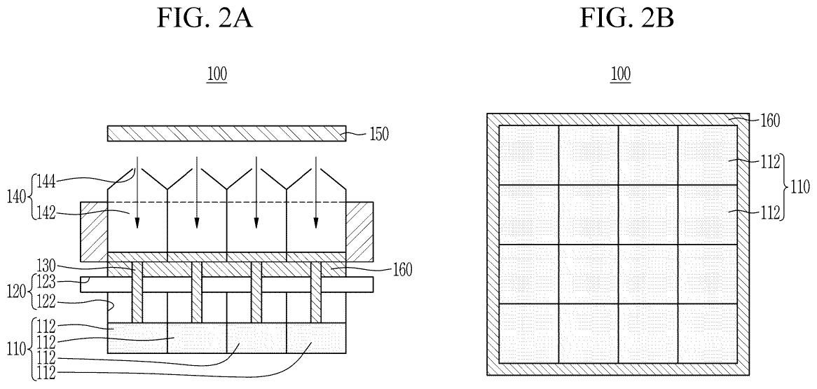

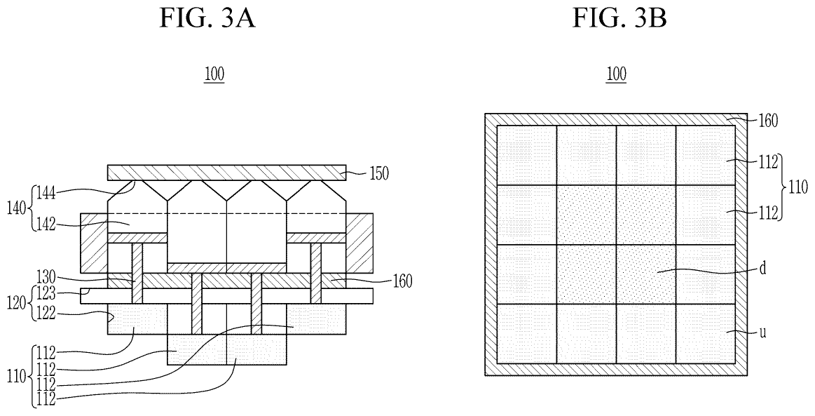

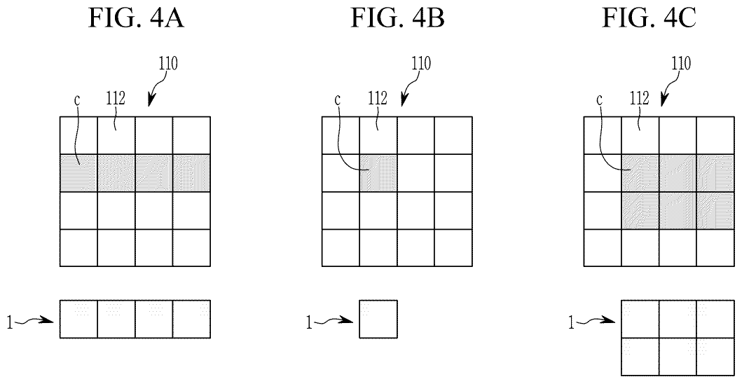

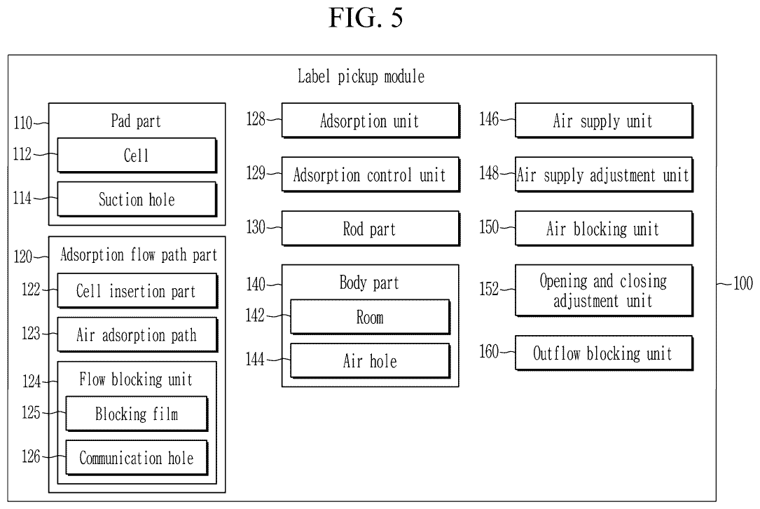

FIG. 1 is a diagram illustrating a label pickup module according to some example embodiments. FIGS. 2A and 2B and 3A and 3B are diagrams for describing a change in shape of a pad part of the label pickup module according to some example embodiments. FIGS. 4A to 4C are diagrams for describing that the pad part of the label pickup module according to some example embodiments can correspond to labels having various sizes. FIG. 5 is a diagram for describing a configuration of a label pickup module according to some example embodiments.

FIG. 1 is a side cross-sectional view of a label pickup module 100. Window (a) of FIG. 1 is an enlarged view illustrating a state in which a cell 112 is inserted into a cell insertion part 122 of an adsorption flow path part 120. Window (b) is an enlarged view illustrating a state in which the cell 112 is not inserted into the cell insertion part 122 of the adsorption flow path part 120 but protrudes.

FIGS. 2A and 3A illustrate side views of the label pickup module 100. FIGS. 2B and 3B schematically illustrate a lower surface of the pad part 110, respectively.

Referring to FIGS. 1 to 5, the label pickup module 100 according to the present disclosure may include a pad part 110 that has one side adsorbing a label 1, an adsorption flow path part 120 as a passage through which air adsorbed through a suction hole 114 of the pad part 110 moves, a rod part 130 that has one side fixed to the other side of the pad part 110 and moves up and down, a room 142 having a hollow shape that accommodates the rod part 130, a body part 140 that has an air hole formed on the upper side as a passage through which air is supplied, and an air blocking unit 150 that opens and closes the air hole 144.

First, the pad part 110 adsorbs an attachment surface of the label 1 through the suction hole 114 formed in the pad part 110. Through this, the label 1 may be fixed to one surface of the pad part 110.

The label pickup module 100 may include an adsorption unit 128 that is connected to the air adsorption path 123 and adsorbs air flowing into the air adsorption path 123.

Specifically, the pad part 110 may include the plurality of cells 112. Referring to the lower cross-section of the pad part 110 illustrated in FIG. 2B, the pad part 110 is composed of 16 cells 112 arranged in 4×4. The pad part 110 illustrated in FIG. 2B illustrates some example embodiments, and the number and arrangement of the cells 112 constituting the pad part 110 are not limited to those illustrated.

Each cell 112 is provided with a suction hole 114, and the suction hole 114 may have a form that penetrates through each cell 112 from one surface of each cell 112 that contacts the label 1 to the other surface.

The adsorption flow path part 120 is disposed on an upper portion of the pad part 110, and may be provided with an air movement path communicating with the plurality of suction holes 114 inside.

The pad part 110 is referred to as one surface that comes into contact with the label 1, which is referred to as a lower portion of the pad part 110. The upper portion of the pad part 110 means an opposite direction in which it is disposed to face the lower portion of the pad part 110.

The adsorption flow path part 120 may include the plurality of cell insertion parts 122 that has a form in which a lower portion is open so that each cell 112 can be inserted, and an air adsorption path 123 that is disposed on an upper side of the plurality of cell insertion parts 122 and communicates with each cell insertion part 122 to have air, which has moved to the cell insertion part 122, move therethrough.

The adsorption flow path part 120 may include a plurality of flow blocking units 124 that are disposed between the plurality of cell insertion parts 122 and the air adsorption paths 123 to adjust air flow between the cell insertion parts 122 and the air adsorption paths 123. As illustrated in FIG. 1, the flow blocking units 124 may be disposed at locations where each of the plurality of cell insertion parts 122 is connected to the air adsorption paths 123.

As illustrated in FIG. 1, the flow blocking unit 124 may include a blocking film 125 that is disposed parallel to the other surface of the cell 112 and a communication hole 126 that is an air movement passage provided in the blocking film 125.

As illustrated in window (a) of FIG. 1, when the cell 112 is inserted into the cell insertion part 122, the rod part 130 moves up. As illustrated in window (b) FIG. 1, when the cell 112 protrudes from the cell insertion part 122, the rod part 130 moves down.

First, as illustrated in window (a) of FIG. 1, when the cell 112 is inserted into the cell insertion part 122, the suction hole 114 of the cell 112 may have a structure in which it is closed by contacting the blocking film 125. In this case, the communication hole 126 of the flow blocking unit 124 may be closed by the other surface of the cell 112. Accordingly, the inside of the adsorption flow path part 120 is completely closed, so when air is adsorbed from one side of the air adsorption path 123, the adsorption force is to adsorb the cell 112 inserted into the pad part 110, that is, the cell insertion part 122.

FIG. 1B illustrates a case where the cell 112 is not inserted into the cell insertion part 122, but protrudes from the cell insertion part 122. In this case, the suction hole 114 of the cell 112 is open. Accordingly, when air is adsorbed from one side of the adsorption flow path part 120 as illustrated in window (a) of FIG. 1, the other surface of the pad part 110 is not adsorbed, but the air inflowing through the suction hole 114 of the cell 112 is adsorbed.

As illustrated, the air flow is sucked from the suction hole 114 of the pad part 110 to the cell insertion part 122, and the air inserted into the cell insertion part 122 moves to the air adsorption path 123 through the open communication hole 126. The air moved to the air adsorption path 123 may be sucked at least to one side along the sucked direction.

The label pickup module 100 according to the present disclosure has a structure in which air may not be sucked through the suction hole 114 of the cell 112 when the rod part 130 moves up and the cell 112 is inserted into the cell insertion part 122, as illustrated in window (a) of FIG. 1. Instead, the cell 112 may be absorbed and fixed.

In addition, as illustrated FIG. 1B, when the rod part 130 moves down and the cell 112 protrudes from the cell insertion part 122, the label pickup module 100 has a structure in which air may be adsorbed through the suction hole 114 of the cell 112. Instead, the cell 112 may not be absorbed.

As a result, the label pickup module 100 according to the present disclosure determines whether the absorption of each cell 112 is possible or impossible at the same time as the plurality of rod parts 130 move up and down.

That is, as each cell 112 moves up and down, the suction hole 114 and the communication hole 26 of each cell 112 is open and closed simultaneously. Herein, simultaneously may refer to actions being performed at exactly or about the same time. By adjusting the up and down movement of each cell 112, the cell 112 where the absorption is performed is automatically designated. For reference, the absorption of the label 1 is possible in an area other than the cell 112 where the absorption is performed.

As a result, the label pickup module 100 according to the present disclosure is significant in that it does not need to separately designate the cell 112 on which the absorption should be performed, as long as each cell 112 moves up and down to change the shape of the pad part 110 according to the size of the label 1. That is, according to some example embodiments, the label pickup module 100 may move each cell 112 up and down to conform the shape of the pad part 110 to the size of the label rather than (e.g., individually, systematically) designating the cells 112.

The rod part 130 is independently moveable up and down while one side is fixed to the other surface of each cell 112, and is included in plurality to correspond to the number of cells 112, respectively.

Although not illustrated, a rod part adjustment unit (not illustrated) that may adjust the up and down movement of the rod part 130 may be further included. Since the shape of the pad part 110 is changed according to the up and down movement of the rod part 130, the rod part adjustment unit may adjust the rod part 130 differently according to the size of the label 1.

The body part 140 may include a room 142 that has a hollow shape and a plurality of air holes 144 that is provided on an upper side of the room 142 and moves air therethrough.

The room 142 may be disposed on an upper side of the absorption flow path part 120. Specifically, the room 142 may be disposed on the other side of the plurality of rod parts 130, and each rod part 130 of the plurality of rod parts 130 may be accommodated.

The room 142 has a hollow shape so that each rod part 130 can move up and down within the room 142 while a portion of the other side of each rod part 130 is accommodated. The number of rooms 142 may be the same as the number of rod parts 130 so that each of the plurality of rod parts 130 may be accommodated.

The plurality of rooms 142 may be provided with the plurality of air holes 144 which are holes through which air is supplied to or discharged from each of the rooms 142. At least one air hole 144 may be provided in each room 142.

The air blocking unit 150 may have a structure that collectively closes the plurality of air holes 144. Accordingly, the air supplied to the room 142 or the air discharged from the room 142 may be collectively blocked.

As illustrated in FIGS. 1 to 3, the rod part 130 is disposed to penetrate through the adsorption flow path part 120 and the body part 140 (specifically, the room 142). The rod part 130 may move up and down while maintaining a structure that penetrates through the adsorption flow path part 120 and the room 142.

In this case, a hole (not illustrated) through which the rod part 130 penetrates is provided in the adsorption flow path part 120 and the room 142, and air may leak out through a gap formed in the hole.

Here, an outflow blocking unit 160 for blocking air flow from the adsorption flow path part 120 and the room 142 may be further included. The outflow blocking unit 160 may be disposed between the adsorption flow path part 120 and the body part 140 (specifically, the room 142).

The up and down movement of the rod part 130 may be achieved by adjusting air supplied through the air hole 144 provided on the upper side of the body part 140.

The label pickup module 100 may include an air supply unit 146. The air supply unit 146 is connected to each air hole 144 and serves to supply air into the room 142. In order to supply air through the air hole 144, it is assumed that the air hole 144 is in an open state. That is, when the air blocking unit 150 is not closing the air hole 144, the air supply unit 146 may supply air through the air hole 144.

When the air hole 144 is open to supply air through the air hole 144, pressure is generated inside each room 142 due to the supplied air. The principle that the rod part 130 moves down is that the rod part 130 is pressed down by the pressure.

In some cases, after opening all the air holes 144, air may be supplied only to some of the plurality of rooms 142. In this case, only the rod part 130 accommodated in some of the rooms 142 to which air is supplied moves down.

In order to maintain the height of the rod part 130 after all or some of the rod parts 130 moves down, the air blocking unit 150 should be used to close all of the air holes 144.

The air blocking unit 150 may collectively close or open all of the plurality of air holes 144. Closing all the air holes 144 at once is to maintain the pressure inside all the rooms 142 in the state just before being closed, so that the position of all the rod parts 130 is maintained at the current state.

That is, by maintaining the pressure inside all of the plurality of rooms 142, the rod part 130 is fixed so that it no longer moves up and down inside the room 142.

On the other hand, when the air hole 144 is kept open and no air is supplied, the pressure inside each room 142 becomes the same as the atmospheric pressure. The rod part 130 is not pressurized, and therefore, does not move down. For example, the rod part 130 simply maintains the current state.

In the state in which some of the rod parts 130 have moved down, that is, in the state in which the heights of the plurality of cells 112 are not constant, the method for making the heights of all the cells 112 constant is as follows.

By supplying air to all of the plurality of rooms 142, all of the plurality of cells 112 may move down. When air is sufficiently supplied to all the rooms 142, the plurality of cells 112 have moved down as much as possible, so the cross-section of the pad part 110 may be flat.

For reference, when the entire label pickup module 100 moves down and uniformly applies pressure to the lower surface of the pad part 110, all the rod parts 130 may uniformly move up by the force pushing up from below.

The label pickup module 100 according to the present disclosure may include the air supply unit 146 that supplies air to each room 142 through then air hole 144, and further include an air supply adjustment unit 148 that controls the air supply unit 146.

The air supply adjustment unit 148 may adjust the air supplied to each room 142 to move the rod part 130 down. This means that each cell 112 moves down, and the air supply adjustment unit 148 adjusts the height of the pad part 110.

The label pickup module 100 according to the present disclosure may further include an opening and closing adjustment unit 152 that controls the air blocking unit 150 to adjust the opening and closing of the air hole 144.

In order to maintain this state after supplying air to the room 142 to adjust the height of the pad part 110, the air hole 144 should be closed. The opening and closing adjustment unit 152 may maintain the current state of the pad part 110 by causing the air blocking unit 150 to close the air hole 144.

Hereinafter, it will be described that the shape of the pad part 110 may change to correspond to the labels 1 having various sizes.

The pad part 110 of the label pickup module 100 according to the present disclosure is composed of the plurality of cells 112, and the height of each cell 112 may be adjusted.

By changing the shape of the pad part 110 to correspond to the contact area with the label 1 by adjusting the height of each cell 112, the labels 1 having various sizes may be picked up with one pad part 110 without replacing the pad part 110.

FIGS. 2A to 3 are diagrams illustrating the change in the shape of the pad part.

Referring to FIG. 2A, it may be confirmed that the plurality of cells 112 have the same height while the pad parts 110 are disposed flatly in a row. Referring to FIG. 2B, which is a simplified drawing of the lower surface of the pad part 110, all 16 cells arranged in 4×4 have a constant height.

Unlike FIG. 2A, FIG. 3A illustrates that the shape of the pad part 110 has changed. The cell 112 disposed in the center is in a downward state, and the cell 112 disposed on the outside is an upward state. Referring to FIG. 3B, among 16 cells arranged in 4×4, it may be seen that 4 cells arranged in 2×2 in the center are in a downward state (d) and the other 12 cells are in an up state (u).

As illustrated in FIGS. 3A and 3B, when the shape of the pad part 110 is changed, as illustrated in FIG. 3B, the label 1 corresponding to the area of the cell (4 cells arranged in 2×2) in the down state (d) may be picked up.

FIGS. 4A to 4C are diagrams for describing that the pad part of the label pickup module according to some example embodiments can correspond to labels having various sizes. FIGS. 4A to 4C each illustrate a cross-section of the labels 1 having various sizes and the pad part 110 of the label pickup module 100 for picking up each label 1 as viewed from below.

FIG. 4A illustrates the label 1 having a size of 1×4 cells, and the area formed by the cell 112, which will be in contact with the label 1 among the plurality of cells 112 of the pad part 110, is indicated by ‘c’. A ‘c’ area is an area corresponding to the label 1. In FIG. 4A, a second row of the cell 112 is indicated by the ‘c’ area, but is not limited thereto. It may be a first row, a third row, or a fourth row of the cell 112, or any one of the first to fourth columns.

FIGS. 4B and 4C illustrate the labels 1 having different sizes from FIG. 4A, respectively. In the cross-section of each pad part 110, the areas formed by the cells 112, which will be in contact with each label 1, is indicated by ‘c’, respectively. The ‘c’ areas illustrated in FIGS. 4B and 4C are areas corresponding to the sizes of each label 1.

The pad part 110 is composed of the plurality of cells 112, and by combining the positions and number of cells 112, the areas of the plurality of combined cells 112 may be variously changed to correspond to the areas of the label 1.

The label pickup module 100 according to the present disclosure may pick up each label 1 using the plurality of cells 112 corresponding to the area indicated by ‘c’ in FIGS. 4A to 4C. Specifically, as illustrated in FIG. 1, the shape of the pad part 110 is changed so that the cells 112 (e.g., the plurality of cells 112 corresponding to the area indicated by ‘c’) corresponding to the area of the label 1 protrude down, thereby allowing the protruding cells 112 to pick up the label 1.

The principle of the label 1 absorbed to the pad part 110 is as described in FIG. 1 above.

Referring to FIG. 1, when the cell 112 is inserted into the cell insertion part 122 as illustrated in window (a) of FIG. 1, the inside of the adsorption flow path part 120 becomes completely closed. Accordingly, when the adsorption unit 128 adsorbs air from one side of the air adsorption path 123, the adsorption force adsorbs the pad part 110, that is, the cell 112 inserted into the cell insertion part 122.

As illustrated in window (b) of FIG. 1, when the cell 112 protrudes from the cell insertion part 122, the suction hole 114 and the communication hole 126 of the cell 112 become both open. Accordingly, when the adsorption unit 128 adsorbs air from one side of the air adsorption path 123, the cell 112 is not adsorbed, but the air inflowing through the suction hole 114 of the cell 112 is adsorbed.

The label pickup module 100 may include an adsorption unit 128 connected to the air adsorption unit 123 to adsorb air inflowing into the air adsorption unit 123, and further include an adsorption control unit 129 that controls the adsorption unit 128.

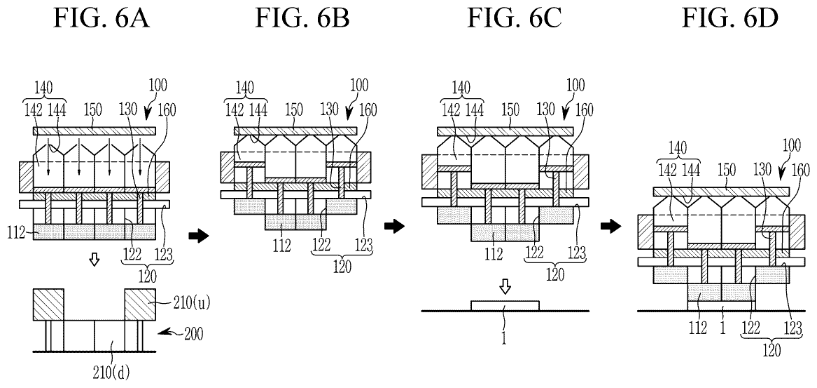

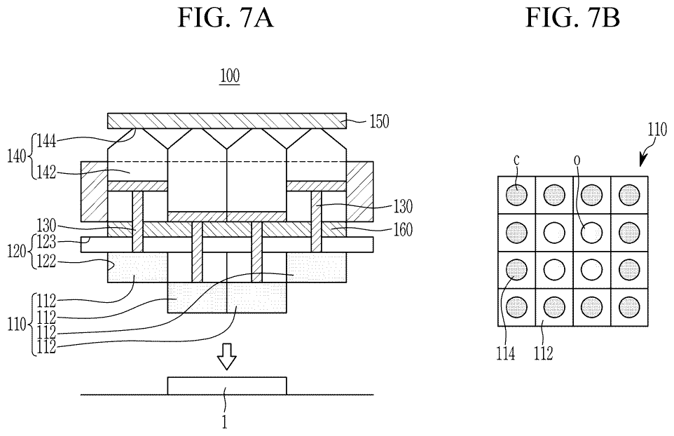

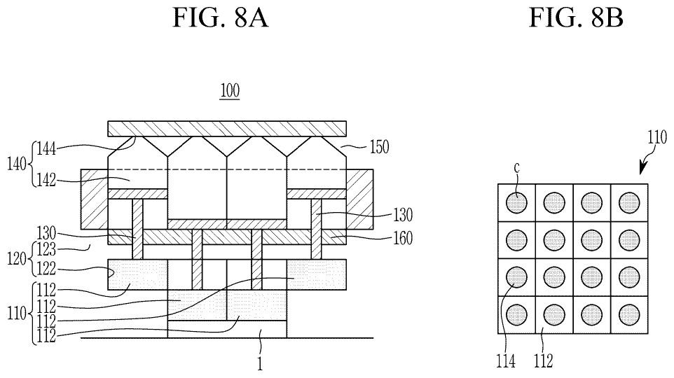

FIGS. 6A to 6D are diagrams illustrating a process of picking up a label using the label pickup module according to some example embodiments. FIGS. 7A and 7B and 8A and 8B are diagrams for describing whether a suction hole is opened or closed during a process of picking up a label by the label pickup module according to some example embodiments.

The process illustrated in FIGS. 6A to 6D illustrates a side view of the label pickup module 100. Although not illustrated in detail in FIGS. 6A to 6D, it is assumed that the label 1 to be picked up has a square shape composed of four cells 112 (in FIG. 3B, the size corresponding to the downward cell 112).

As described above, the opening and closing of each suction hole 114 is determined according to the height of each cell 112. Accordingly, it is desirable to adjust the height of each cell 112, e.g., the shape of the pad part 110, and the shape of the pad part 110 may be changed using the jig module 200.

FIG. 6A illustrates a side view of the label pickup module 100 and the jig module 200 disposed below the label pickup module 100. FIG. 6A illustrates a process of changing the pad part 110 of FIG. 6A into the shape similar to FIG. 6B using the jig module 200.

The jig module 200 is a jig for adjusting the height of the cell 112 of the pad part 110 to correspond to the size of the label 1 to be picked up. The jig module 200 serves to change the shape of the pad part 110 to fit the size of the label 1. A plurality of jig cells 210 of the jig module 200 may move up and may also maintain a state of being arranged down.

The jig module 200 includes the same number of jig cells 210 as the number of cells 112 of the pad part 110, and the jig cells 210 correspond to the sizes and positions of the plurality of cells 112 of the pad part 110.

Accordingly, the appearance of the jig cells 210 of the jig module 200 as seen from above may be similar to the appearance (16 cells arranged in 4×4) of the plurality of cells 112 of the pad part 110.

In order to pick up the label 1, among the plurality of cells 112 of the pad part 110, the cell 112 that contacts the label 1 and attaches the label 1 should move up and down so that it protrudes from the cell insertion part 122, and the other cells 112 are inserted into the cell insertion part 122 (refer to the shape of the pad part 110 illustrated in FIG. 6B).

In order to change the shape of the pad part 110, as illustrated in FIG. 6A, the shape of the jig module 200 should be changed first.

The shape of the jig module 200 illustrated in FIG. 6A is for changing the shape of the pad part 110 as illustrated in FIG. 6B. Accordingly, the height of the jig cell 210 of the jig module 200 should be changed so that it becomes a position that is inverted from the height of the plurality of cells 112 of the pad part 110 illustrated in FIG. 6B (refer to the shape of the jig module 200 illustrated in FIG. 6A).

For example, in order to pick up the label 1 having the size of the cells 112 arranged in 2×2, the shape of the pad part 110 should be changed to correspond to the label 1. That is, by adjusting the height of the cell 112 of the pad part 110, the cell 112 that comes into contact with the label 1 should be protruded down, and the other cells 112 should be inserted into the cell insertion part 122 (see FIG. 6B).

Therefore, the jig cell 210 (u) corresponding to the cell 112 that is lowered down should be in an upward state (up), and the jig cell 210 (d) corresponding to the cell 112 that is raised up should be in a downward state (down).

Hereinafter, the process of picking up the label 1 will be described while sequentially describing the drawings of FIGS. 6A to 6D (see the configuration of FIG. 5).

FIGS. 6A and 6B illustrate the process of changing the shape of the pad part 110 of the label pickup module 100 to fit the shape of the pad part 110 to the size of the label 1.

First, FIG. 6A illustrates the state in which after the height of the pad part 110 is made into a flat shape to be constant, the pad part 110 moves downward toward the jig module 200 located below the label pickup module 100.

In order to make the pad part 110 into the flat shape, the air blocking unit 150 should be separated from the air hole 144 so that the air hole 144 is in an open state. In this state, the air supply unit 146 may supply air through the air hole 144.

The air is supplied to the room 142, and the pressure inside the room 142 increases.

As the pressure of the supplied air pressurizes the other side of the rod part 130 disposed inside the room 142, the rod part 130 moves downward as the air is supplied. As illustrated in FIG. 6A, air may be supplied until the shape of the pad part 110 becomes flat (until the heights of all the cells 112 become constant).

In the state in which the shape of the pad part 110 becomes flat, the label pickup module 100 moves toward the jig module 200 disposed below.

In the jig module 200 illustrated in FIG. 6A, the jig cell 210 that comes into contact with the portion of the pad part 110 where the label 1 is attached is maintained in the state 210(d) where it is disposed below, and the other portions are maintained in the state 210(u) where they protrude upward.

In order to change the shape of the pad part 110 of the label pickup module 100 by using the jig module 200 in FIG. 6A, the pad part 110 moves toward the jig cell 210 of the jig module 200. The label pickup module 100 may move downward until the lower surface of at least one pad part 110 comes into contact with the jig module 200. During this process, the air hole 144 is maintained in an open state.

During the process in which the label pickup module 100 presses the jig module 200, some of the cells 112 (rod part 130) that have been lowered down move upward by the pressure.

Referring to FIG. 7B (diagram illustrating the suction hole 114 formed on the lower surface of the pad part 110) to be described below, the cell 112 in the ‘c’ area is pushed upward by the jig cell 210(u) that is in an upward state among the jig modules 200. Referring to FIG. 6B, it may be seen as a circumference area of the pad part 110 that is raised up.

On the other hand, the cell 112 in an ‘o’ area of FIG. 7B does not come into contact with the jig cell 210(d), so it does not move upward and may maintain the current state of being lowered. Referring to FIG. 6B, it may be seen as a center area of the pad part 110 that is lowered down.

Depending on the shape of the jig module 200, the air hole 144 was maintained in an open state during the process of the cell 112 moving up and down.

However, after the cell 112 moves up and down and the position is determined, the air hole 144 is closed (FIG. 6B). The air blocking unit 150 may collectively be closed the plurality of air holes 144.

The rod parts 130 having different heights are accommodated in each room 142. In this state, the pressure inside the room 142 is maintained constantly by closing the air hole 144. When the pressure is kept constant, the height of the rod part 130 does not change unless an external force is applied and is kept constant. Accordingly, the shape of the pad part 110 may maintain the shape corresponding to the size of the label 1.

FIG. 6C is a diagram illustrating a process in which the label pickup module 100, whose shape is changed to correspond to the size of the label 1 to be picked up, moves toward the label 1.

As the upper and lower positions of each cell 112 of the pad part 110 are determined, the opening and closing of the suction hole 114 of each cell 112 is determined simultaneously.

In FIG. 6C, the cell 112 that is lowered down has the suction hole 114 open, and is in a state in which it may absorb the label 1 that will come into contact with one surface of the cell 112.

On the other hand, the cell 112 that is raised up (the cell 112 inserted into the cell insertion part 122) has the suction hole 114 blocked, and is in a state in which the air absorption is impossible.

FIG. 7A illustrates the appearance of FIG. 6C. FIG. 7B schematically illustrates the lower surface of the pad part 110. It is illustrated to describe the state of the suction hole 114 of each cell 112, and the suction hole 114 disposed in each cell 112 is illustrated as a single circle.

As illustrated in FIG. 7B, the suction hole 114 (o) provided in the cell 112 that is lowered down is in an open state (see window (b) of FIG. 1).

Among the cells 112 of the pad part 110 arranged in 4×4, four cells 112 arranged in the middle, that is, the cells 112 arranged in 2×2, are in an open state (indicated by ‘o’). Twelve cells 112 arranged on the circumference are in a closed state (indicated by ‘c’). The label 1 corresponds to the size of the cell 112 in the open state indicated by ‘o’.

In the cell 112 inserted into the cell insertion part 122, the suction hole 114 (c) is in a closed state (see window (a) of FIG. 1).

FIG. 6D illustrates a state in which the pad part 110 is in contact with the attachment surface of the label 1. In this case, the adsorption control unit 129 may control the adsorption unit 128 to absorb air. The absorption control unit and absorption unit may also be referred to as suction control unit and suction unit, respectively.

In the cell 112 that is lowered down, the suction hole 114 is in an open state, so that the label 1 may be absorbed and fixed to the pad part 110.

FIG. 8A illustrates the appearance of FIG. 6D. FIG. 8B schematically illustrates the lower surface of the pad part 110, and is a diagram for describing the state of the suction hole 114 of each cell 112.

In FIG. 7B, the suction hole 114 (o) that was in the open state has changed to the closed state (close) in FIG. 8B. This is because the suction hole 114 (o) that was in the open state is in the closed state (close) as the lower surface of the cell 112 comes into contact with the label 1. In this case, the adsorption force generated in the suction hole 114 of the cell 112 that comes into contact with the label 1 absorbs the label 1.

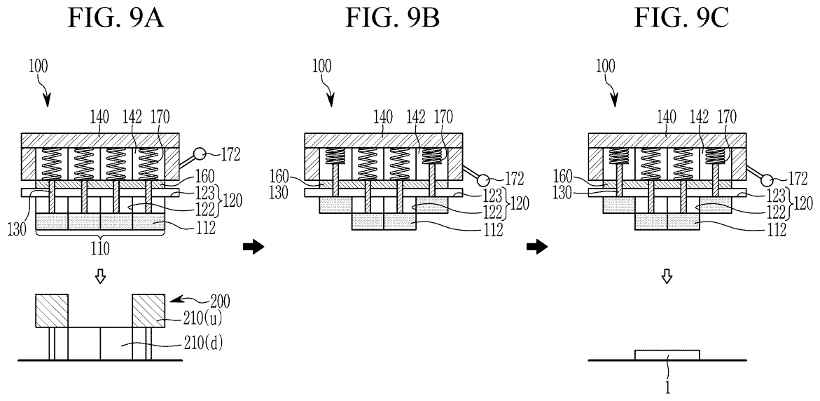

FIGS. 9A to 9C are diagrams illustrating a label pickup module according to some example embodiments.

In the case of some example embodiments illustrated in FIGS. 1 to 8A and 8B, the movement of the rod part 130 is due to the pressure of the air supplied to the air hole 144. The label pickup module 100 of FIGS. 9A to 9C is different in that the movement of the rod part 130 is due to an elastic force of an elastic part 170.

Accordingly, some example embodiments illustrated in FIG. 9A is different from some example embodiments of FIGS. 1 to 8A and 8B in the structure of the body part 140. The body part 140 illustrated in FIGS. 9A to 9C includes the room 142 that accommodates the elastic part 170. However, the body part 140 has the shape in which the upper side is closed and does not include the air hole 144.

The other components, the pad part 110 and the adsorption flow path part 120, are the same. Similarly, the cell 112 is inserted into the lower portion of the adsorption flow path part 120, and the adsorption flow path part 120 is structured to communicate with the suction hole 114 provided in each cell 112, so that the label 1 may be absorbed using the adsorption force through the suction hole 114 (see window (b) of FIG. 1).

FIGS. 9A and 9B are processes of changing the height of the cell 112 using the jig module 200.

FIG. 9A illustrates a state in which all the cells 112 are lowered, and the pad part 110 maintains a flat shape.

Although not illustrated in detail, the label pickup module 100 may further include a lever 172 connected to the body part 140 as illustrated in FIG. 9A. The lever 172 serves to maintain the shape of the elastic part 170. When the elastic part 170 is compressed, it is to maintain the compressed state.

In FIGS. 9A, the elastic part 170 is not compressed, so the lever 172 maintains the open state (unlocking).

When the label pickup module 100 moves toward the jig module 200 along the arrow direction illustrated in FIG. 9A, some cells 112 move upward by the jig module 200 having different heights.

As illustrated in FIG. 9B, when the cell 112 moves upward by the jig module 200, the elastic part 170 connected to one side of the rod part 130 connected to the cell 112 that has moved upward is in the compressed state compared to FIG. 9A.

Since the compressed elastic part 170 in FIG. 9B has a force to restore to the state of FIG. 9A, it is necessary to maintain the state of the elastic part 170 in order to maintain the current height of the cell 112.

As illustrated in FIG. 9B, the lever 172 connected to the body part 140 may be operated (locked) to maintain the shape of the elastic part 170. After fixing the height of the cell 112 by using the lever 172, it may move to pick up the label 1 as in FIG. 9C.

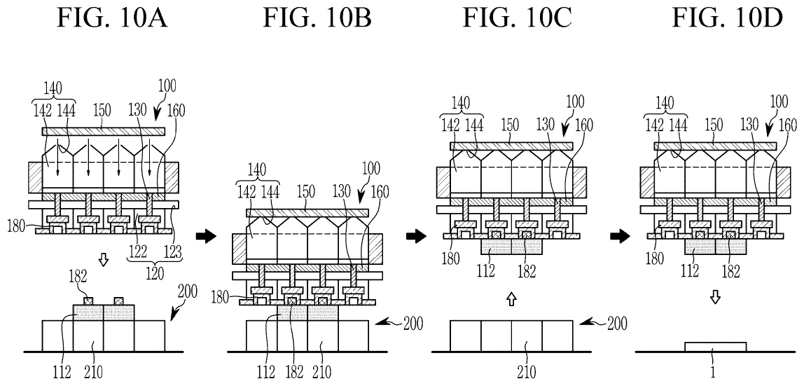

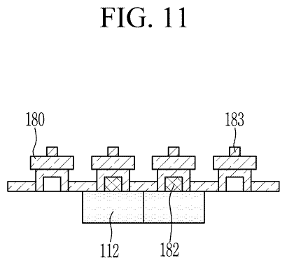

FIGS. 10A to 10D are diagrams illustrating a label pickup module according to some example embodiments. FIG. 11 is a diagram illustrating a detachable structure of the label pickup module according to

FIGS. 10A to 10D. FIGS. 10A to 10D is a diagram illustrating some example embodiments of the label pickup module 100.

In the label pickup module 100 of FIGS. 1 to 9, the cell 112 was coupled to the label pickup module 100, and the pad part 110 in the state was used to pressurize the jig module 200, thereby changing the shape of the pad part 110.

On the other hand, the label pickup module 100 of FIGS. 10A to 10D is different in that the cell 112 disposed on the jig module 200 is coupled to the label pickup module 100.

The cell 112 is disposed on the jig module 200 itself to correspond to the size of the label 1, and then the disposed cell 112 is coupled to the label pickup module 100.

The other components, such as the adsorption flow path part 120, the rod part 130, the body part 140, and the air blocking unit 150, are the same. Similarly, the cell 112 may be coupled to the lower portion of the adsorption flow path part 120, and the adsorption flow path part 120 may be structured to communicate with the suction hole 114 provided in each cell 112 (see window (b) of FIG. 1).

In FIGS. 1 to 9A to 9C, the other side of the rod part 130 is directly fixed to the other surface of each cell 112. In contrast, some example embodiments illustrated in FIGS. 10A to 10D does not describe a structure in which the rod part 130 and the cell 112 are directly connected, but further describes a separate coupling structure that the rod part 130 and the cell 112 are connected.

Referring to FIG. 10A, a first coupling part 180 is connected to the other side of the rod part 130. A second coupling part 182 coupled connected to the first coupling part 180 is connected to the other side of each cell 112.

As an example, the coupling method of the first coupling part 180 and the second coupling part 182 may be a clamp method. The first coupling part 180 may be a button-type clamp, and the second coupling part 182 may have a protruding shape that is coupled to the button-type clamp.

FIGS. 10A and 10B are diagrams illustrating a process of coupling the cell 112 to the label pickup module 100. When the first coupling part 180 and the second coupling part 182 are coupled, the coupling is possible when pressure is applied from the top toward the bottom.

FIG. 10C illustrates a state in which the label pickup module 100 to which the cell 112 is coupled moves away from the jig module 200. In this case, as illustrated in window (b) of FIG. 1, the suction hole 114 of the attached cell 112 and the communication hole 126 of the air adsorption path 123 are kept open.

FIG. 10D illustrates a state in which the cell 112 of the label pickup module 100 moves downward to attach the label 1.

Since the suction hole 114 provided in the cell 112 of the label pickup module 100 is kept open, when it is positioned to come into contact with the label 1 and the adsorption unit 128 starts to absorb, the label 1 may be picked up in a state in which it is absorbed on one surface of the cell 112.

FIG. 11 is a diagram illustrating a module form in which the second coupling part 182 of the cell 112 is coupled to the first coupling part 180.

In the case of the embodiment of FIGS. 10A to 10D, the separation is possible with a module structure such as FIG. 11. Accordingly, when detaching the first coupling part 180 and the second coupling part 182, after separating them as illustrated in FIG. 11, the pressure is applied to the button part 183 provided on the upper side of the first coupling part 180.

As some example embodiments, although not illustrated in the drawing, the label pickup module 100 may further include a magnetic part (not illustrated) in each cell 112 that has magnetism. The magnetic part may be disposed at the position of the second coupling part 182 in FIGS. 10A to 10D. A magnetic coupling part (not illustrated) that magnetically couples with the magnetic part may be disposed at a position corresponding to the first coupling part 180.

The label pickup module 100 may further include a magnetic control unit that controls magnetism generated between the magnetic unit and the magnetic coupling unit. The magnetic control unit may control magnetism as needed during the process of coupling the plurality of cells 112 to the label pickup module 100.

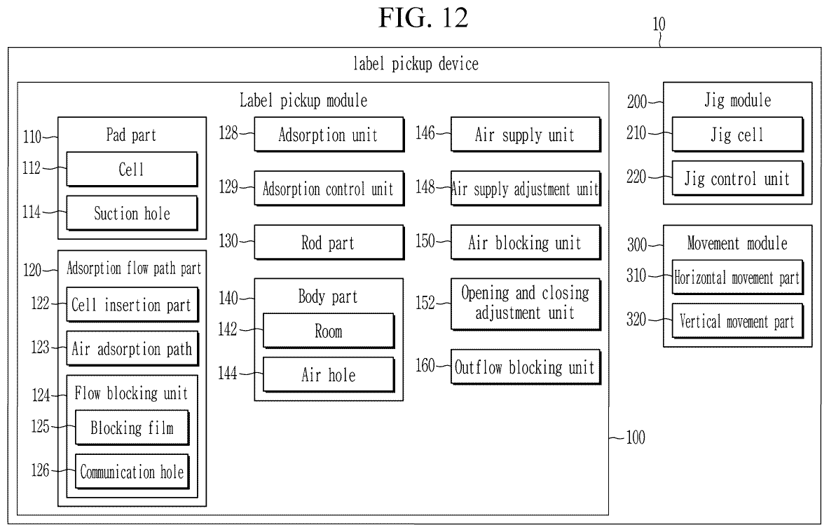

FIG. 12 is a diagram for describing a configuration of a label pickup device according to some example embodiments.

As illustrated in FIG. 12, the label pickup device 10 according to the present disclosure includes the label pickup module 100 described in FIGS. 1 to 11.

The label pickup module 100 includes the pad part 110 that includes the plurality of cells 112 and the plurality of suction holes 114 penetrating through each of the plurality of cells 112, the adsorption flow path part 120 that is disposed on the upper portion of the pad part 110 and has the air movement passage formed therein and communicating with the plurality of suction holes, the body part 140 that is disposed on the other side of the plurality of rod parts 130 whose one side is fixed on the other surface of each cell 112, and the air blocking unit 150 that opens and closes the plurality of air holes 144.

The label pickup device 10 may include the label pickup module 100, the jig module 200 that includes divided jig cells 210 corresponding to the plurality of cells 112, and the movement module 300 that is connected to the label pickup module 100 and moves the label pickup module 100.

The jig module 200 includes the plurality of jig cells 210, and the plurality of jig cells 210 can independently move up and down.

The jig module 200 may further include the jig control unit 220 that controls the up and down movement of the plurality of jig cells 210. The jig control unit 220 may control at least one jig cell 210 to move down and the other jig cells 210 to move up.

The movement module 300 may include a horizontal movement unit 310 that moves the label pickup module 100 horizontally, and a vertical movement unit 320 that moves the label pickup module 100 vertically.

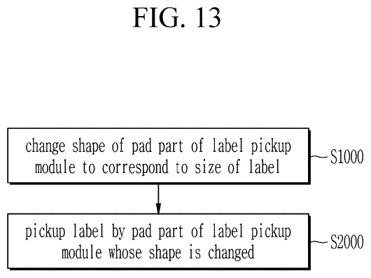

FIG. 13 is a diagram illustrating a label pickup method according to some example embodiments.

As illustrated in FIG. 13, the label pickup method according to the present disclosure is a method of picking up a label 1 using the label pickup device 10 having the pad part 110 including the plurality of cells 112, and may include a step (S1000) of changing the shape of the pad part 110 of the label pickup module 100 to correspond to the size of the label 1, and a step (S2000) of picking up, by the pad part 110 whose shape has been changed, the label 1.

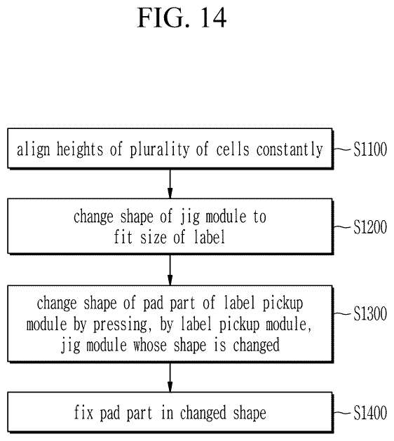

FIGS. 14 to 17A to 17E are diagrams illustrating a process of changing the shape of the pad part 110 of the label pickup module 100 to correspond to the size of a label 1 in the label pickup method according to FIG. 13.

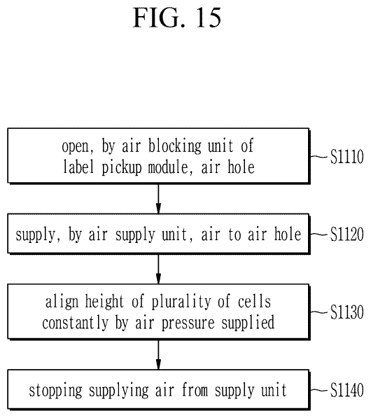

FIGS. 14 and 15 are flowcharts illustrating a step of changing the shape of the pad part 110 to correspond to the size of the label 1.

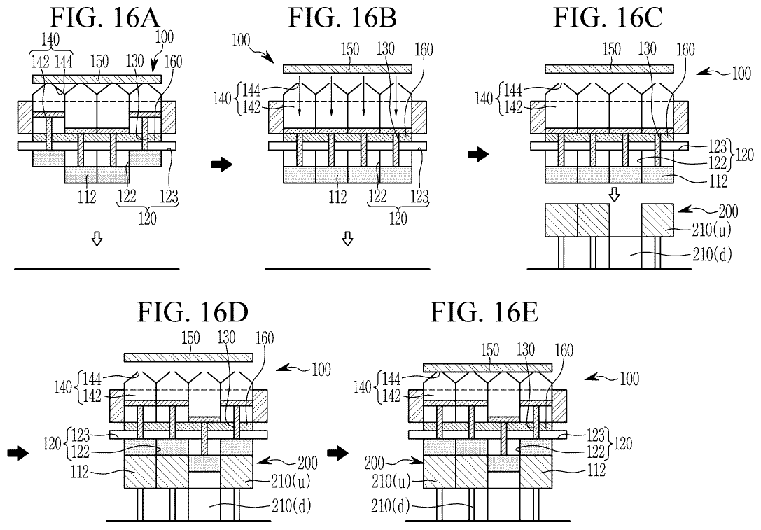

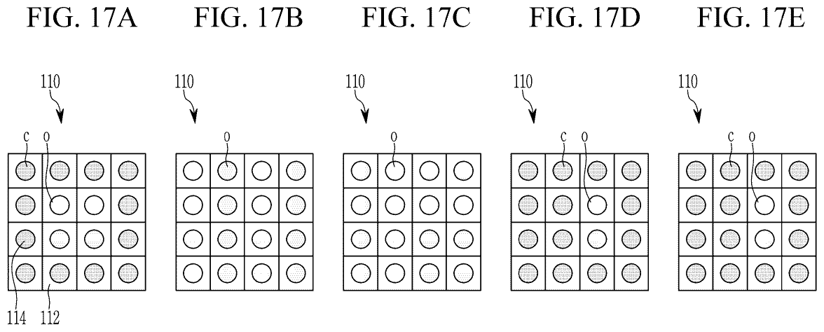

FIGS. 16A to 16E are diagrams illustrating a flowchart of a process of changing, by the label pickup device 10 according to the present disclosure, the shape of the pad part 110. FIGS. 17A to 17E are diagrams illustrating whether the plurality of suction holes 114 provided in the pad part 110 are open or closed during the process in which the shape of the pad part 110 is changed according to FIGS. 16A to 16E.

Referring to FIGS. 14 and 16A to 16E, the step of changing the shape of the pad part 110 of the label pickup module 100 to correspond to the size of the label 1 may include a step (S1100) of aligning the heights of the plurality of cells 112 constantly (FIGS. 16A and 16B), a step (S1200) of changing the shape of the jig module 200 to correspond to the size of the label 1 (FIG. 16C), a step (S1300) of changing the shape of the pad part 110 of the label pickup module 100 by applying the pressure from the upper side of the jig module 200 whose shape has been changed (FIG. 16D), and a step (S1400) of fixing the pad part 110 in the changed shape (FIG. 16E).

In addition, referring to FIGS. 15 and 16A to 16E, the step of aligning the heights of the plurality of cells 112 constantly may include a step (S1110) of opening, by the air blocking unit 150 of the label pickup module 100, the air hole 144, a step (S1120) of supplying, by the air supply unit 146, air to the air hole 144, a step (S1130) of aligning the heights of the plurality of cells 112 constantly by the supplied air pressure, and a step (S1140) of stopping supplying air from air supply unit 146 (FIGS. 16A and 16B).

Referring to FIGS. 14 and 16A to 16E, the step (S1200) of changing, by the jig module 200, its shape to fit the size of label 1 may include a process of moving, by the jig control unit 220, the plurality of jig cells 210 of the jig module 200 up and down to change the height to fit the label size (FIG. 16C).

Referring to FIGS. 14 and 16A to 16E, the step (S1400) of fixing the pad part 110 in the changed shape may include a process of closing, by the air blocking unit 150 of the label pickup module 100, the air hole 144 (FIG. 16E).

FIG. 17 is a diagram illustrating whether the plurality of suction holes 114 provided in the pad part 110 are open or closed in the process of FIGS. 16A to 16E.

The label pickup method according to the present disclosure is that, as each cell 112 of the pad part 110 moves up and down, the opening and closing of the suction hole 114 and the communication hole 126 of each cell 112 are simultaneously performed. When only the up and down movement of each cell 112 is adjusted, the cell 112 capable of absorption is automatically designated. Here, the area excluding the cell 112 where the absorption is performed is the area where the label 1 may be absorbed.

Therefore, as illustrated in FIG. 7A, only the suction hole 114 arranged in the 2×2 cells 112 disposed in the center is in the open state (o), and the suction holes 114 provided in the other cells 112 are in the closed state (c).

In FIGS. 16B and 16C, all the cells 112 are lowered down, and in FIGS. 17B and 17C, as illustrated in window (b) of FIG. 1, all the suction holes 114 are in the open state (o).

In FIGS. 16D and 16E, some cells 112 come into contact with the jig cell (210(u)) that is raised upward, and the cells 112 that come into contact move upward and the cells 112 that do not come into contact remain in the lowered state. As illustrated in FIGS. 17D and 17E, the suction holes 114 provided in the cells 112 that come into contact with the jig cell 210(u) are in the closed state (c), and the suction holes 114 provided in the cells 112 that do not come into contact with the jig cell 210(d) are in the open state (o).

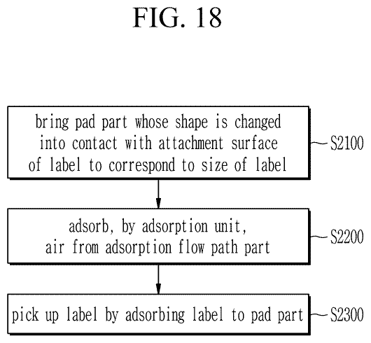

FIGS. 18 to 21 are diagrams illustrating a process of picking up, by the pad part 110 of the label pickup module 100, the label 1 and detaching the label 1 from the pad part 110 in the label pickup method according to FIG. 13.

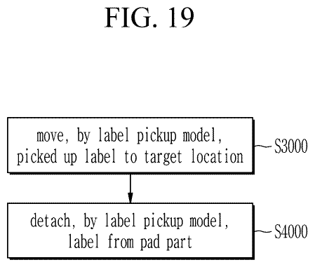

FIG. 18 is a flowchart illustrating a step of picking up, by the pad part 110, the label 1. FIG. 19 is a flowchart illustrating a step of detaching the label 1 from the pad part 110.

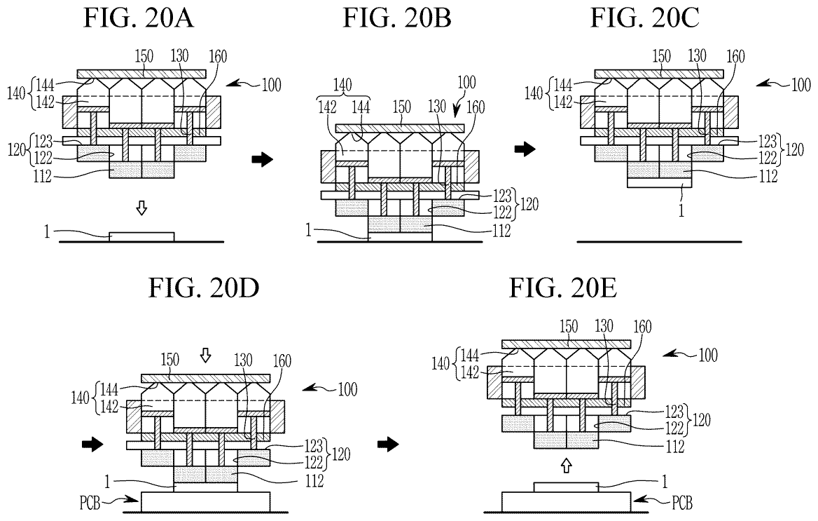

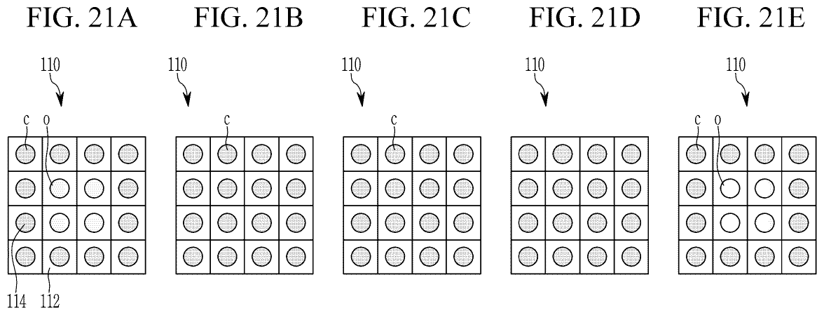

FIGS. 20A to 20E are flowcharts illustrating a process of picking up, by the pad part 110 of the label pickup device 10 according to the present disclosure, the label 1 and detaches the label 1 from the pad part 110. FIGS. 21A to 21E are diagrams illustrating whether the plurality of suction holes 114 provided in the pad part 110 are open or closed in the process of FIGS. 20A to E.

Referring to FIGS. 18 to 20E, the step of picking up, by the pad part 110 of the label pickup module 100, whose shape has been converted, the label 1 may include a step (S2100) (FIGS. 20A and 20B) of bringing the pad part 110, whose shape has been converted, into contact with the attachment surface of the label 1 to correspond to the size of the label 1 (FIG. 20B), and a step (S2200) of adsorbing, by the adsorption unit 128, air from the adsorption flow path part 120 (FIG. 20B), and a step (S2300) of picking up the label 1 by being adsorbed by the pad part 110 (FIG. 20C)).

As illustrated in FIGS. 19 and 20D and 20E, after the label 1 is picked up by being adsorbed by the pad part 110, a process of attaching the label 1 to a target product (e.g., a PCB) may be performed.

The process of attaching the label 1 to the target product (e.g., PCB) may include a step (S3000) of moving, by the label pickup module 100, the picked up label 1 to the target location (FIGS. 20C and 20D), and a step (S4000) of detaching, by the label pickup module 100, the label 1 from the pad part 110 (FIG. 20E).

At the same time that the label 1 is detached from the pad part 110, the label 1 may be attached to the target product (e.g., PCB) (FIG. 20E). The step (S4000) of detaching the label 1 from the pad part 110 may include a process of stopping, by the adsorption part 128, absorbing air.

FIGS. 21A to 21E are diagrams illustrating whether the plurality of suction holes 114 provided in the pad part 110 are open or closed in the process of FIGS. 20A to E.

The label pickup method according to the present disclosure is that, as each cell 112 of the pad part 110 moves up and down, the opening and closing of the suction hole 114 of each cell 112 are simultaneously performed. When only the up and down movement of each cell 112 is adjusted, the cell 112 capable of absorption is automatically designated.

Therefore, as illustrated in FIG. 21A, only the suction hole 114 arranged in the 2×2 cells 112 disposed in the center is in the open state (o), and the suction holes 114 provided in the other cells 112 are in the closed state (c).

That is, in the case where the shape of the pad part 110 is fixed, the opening and closing of the suction hole 114 of each cell 112 is fixed. Accordingly, in the next step, the label 1 having the size corresponding to the suction hole 114 in the open state (open, o) is attached and absorbed to the suction hole 114 in the open state (o).

In FIGS. 20B, 20C, and 20D, the label 1 is attached to the cell 112 that is lowered down. Accordingly, in FIGS. 21B, 21C, and 21D, the suction hole 114 of the cell 112 that was in the open state (o) in FIG. 21A becomes the closed state (c) by the label 1.

In FIG. 20E, the label 1 is detached from the cell 112 that is lowered down, and the suction hole 114 provided in the cell 112 disposed in a 2×2 arrangement in the center in FIG. 21E becomes the open state (open, o) as illustrated in FIG. 21A.

Although some example embodiments of the present disclosure have been described above, the present disclosure is not limited thereto, and the present disclosure can be variously modified within the scope of the claims, the detailed description of the present disclosure, and the appended drawings, and it is natural that various modifications also fall within the scope of the present disclosure.

What is claimed is:

1. A label pickup module, comprising:
a pad part including a plurality of cells and a plurality of suction holes penetrating through each cell from one surface of each of the plurality of cells contacting labels to the other surface;
an adsorption flow path part on an upper portion of the pad part and an air movement passage formed therein, communicating with the plurality of suction holes;
a plurality of rod parts having one side fixed to each of the cells and independently movable up and down;
a body part on the other side of the plurality of rod parts, including a plurality of rooms having a hollow shape configured to move while accommodating each of the plurality of rod parts, and having a plurality of air holes configured to move air through each of the plurality of rooms; and
an air blocking unit configured to open and close the plurality of air holes.

2. The label pickup module of claim 1, further comprising:
an outflow blocking unit between the adsorption flow path part and the body part, and configured to block an air flow flowing out from the adsorption flow path part and the body part.

3. The label pickup module of claim 1, wherein the adsorption flow path part includes:
a plurality of cell insertion parts including a lower portion configured to accommodate each cell being inserted;
an air adsorption path on an upper side of the plurality of cell insertion parts and configured to communicate with each cell insertion part to have air, which has moved to the cell insertion part, move therethrough;
a plurality of flow blocking units between the plurality of cell insertion parts and the air adsorption path configured to adjust an air flow between the cell insertion parts and the air adsorption path; and
an adsorption unit connected to the air adsorption path configured to adsorb air.

4. The label pickup module of claim 3, further comprising:
an adsorption control unit configured to control the adsorption unit.

5. The label pickup module of claim 3, wherein each of the flow blocking units includes:
a blocking film parallel to the other surface of each cell; and
a communication hole configured to move air in the blocking film.

6. The label pickup module of claim 5, wherein
based on the cell being inserted into the cell insertion part, the suction hole of the cell is closed by contacting the blocking film.

7. The label pickup module of claim 1, wherein the air blocking unit has a structure configured to collectively close the plurality of air holes.

8. The label pickup module of claim 1, further comprising:
an air supply unit connected to each air hole of the plurality of air holes and configured to supply air to each air hole.

9. The label pickup module of claim 8, further comprising:
an air supply adjustment unit configured to control the air supply unit; and
an opening and closing adjustment unit configured to control the air blocking unit to adjust the opening and closing of the air hole.

10. A label pickup device, comprising:
a label pickup module including
a pad part including a plurality of cells and a plurality of suction holes penetrating through each cell of the plurality of cells,
an adsorption flow path part having an air movement passage communicating with the plurality of suction holes,
a body part on the other side of a plurality of rod parts having one side fixed to each cell, and
an air blocking unit configured to block air movement with an inside of the body part;
a jig module including divided jig cells corresponding to the plurality of cells, the plurality of jig cells configured to be independently moveable up and down; and
a movement module connected to the label pickup module and configured to move the label pickup module.

11. The label pickup device of claim 10, wherein the movement module includes:
a horizontal movement part configured to horizontally move the label pickup module; and
a vertical movement part configured to vertically move the label pickup module.

12. The label pickup device of claim 10, further comprising:
a jig control unit configured to control the up and down movement of the plurality of jig cells,
wherein the jig control unit is configured to control at least one jig cell to move down and the other jig cells to move up.

13. A label pickup method of picking up a label using a label pickup device having a pad part including a plurality of cells, the label pickup method comprising:
changing a shape of the pad part to correspond to a size of the label; and
picking up the label by the pad part whose shape is changed.

14. The label pickup method of claim 13, wherein
the changing of the shape of the pad part to correspond to the size of the label includes:
aligning heights of the plurality of cells constantly;
changing the shape of a jig module to fit the size of the label;
pressing an upper side of the jig module whose shape is changed to change the shape of the pad part of a label pickup module; and
fixing the pad part in the changed shape.

15. The label pickup method of claim 14, wherein the aligning of the heights of the plurality of cells constantly includes:
opening, by an air blocking unit of the label pickup module, an air hole;
supplying, by an air supply unit, air to the air hole;
aligning the heights of the plurality of cells constantly, by supplied air pressure; and
stopping supplying air from the air supply unit.

16. The label pickup method of claim 14, wherein the changing of the shape of the jig module to fit the size of the label includes:
moving, by a jig control unit, a plurality of jig cells of the jig module up and down to change the height to fit the size of the label.

17. The label pickup method of claim 14, wherein the fixing of the pad part to the changed shape includes:
closing, by an air blocking unit of the label pickup module, an air hole.

18. The label pickup method of claim 13, wherein the picking up of, by the pad part whose shape is changed, the label includes:
bringing the pad part whose shape is changed into contact with an attachment surface of the label to correspond to the size of the label;
adsorbing, by an adsorption unit, air from an adsorption flow path part; and
picking up the label by adsorbing the label to the pad part.

19. The label pickup method of claim 13, further comprising:
moving, by the label pickup module, the picked up label to a target location; and
detaching, by the label pickup module, the label from the pad part.

20. The label pickup method of claim 19, wherein
in the detaching of the label from the pad part,
the adsorption unit stops absorbing the air.
